(19) United States
(12) Patent Application Publication
(10) Pub. No.: US 2026/0205018 A1
(43) Pub. Date: Jul. 16, 2026

(54) POWER CONVERSION CIRCUIT AND PROGRAMMING METHOD THEREOF THAT PROGRAMS CONTROL CIRCUIT ON PRIMARY SIDE FROM SECONDARY SIDE THROUGH ISOLATION DEVICE

(71) Applicant: Richtek Technology Corporation, Zhubei City (TW)

(72) Inventors: Tzu-Chen LIN, Zhubei City (TW); Chih-Hua HOU, Zhubei City (TW); Chien-Fu TANG, Hsinchu City (TW)

(21) Appl. No.: 19/408,592

(22) Filed: Dec. 4, 2025

Related U.S. Application Data
(60) Provisional application No. 63/744,897, filed on Jan. 14, 2025.

(30) Foreign Application Priority Data
Aug. 25, 2025 (TW) 114132285

(51) Int. Cl. H02M 3/335; H02M 1/42; H02M 7/217

(52) U.S. Cl. CPC H02M 3/33569; H02M 1/4208; H02M 7/217

(57) ABSTRACT

A power conversion circuit includes an isolated power converter, an isolation device, a primary control circuit, and a secondary control circuit. The isolated power converter includes a transformer. The transformer includes a primary coil and a secondary coil, and the secondary coil generates an output voltage. The isolation device generates a feedback signal based on a feedback current. The primary control circuit magnetizes and demagnetizes the primary coil based on the feedback signal. The secondary control circuit generates the feedback current based on the output voltage. When the power conversion circuit operates in a programming mode, the secondary control circuit provides a program code to the primary control circuit through the isolation device.

### CROSS REFERENCE TO RELATED APPLICATIONS

This application claims the benefit of U.S. Provisional Application No. 63/744,897, filed on January 14, 2025, the entirety of which is incorporated by reference herein.

This Application claims priority of Taiwan Patent Application No. 114132285, filed on Aug. 25, 2025, the entirety of which is incorporated by reference herein.

### BACKGROUND OF THE INVENTION

### Field of the Invention

The disclosure is generally related to a power conversion circuit and a programming method thereof, and more particularly it is related to a power conversion circuit and a programming method thereof that programs the control circuit on the primary side from the secondary side through an isolation device.

### Description of the Related Art

Isolated power conversion circuits often incorporate a transformer, which divides the circuit into a primary side and secondary side, isolating the voltages on the primary side and secondary side. Therefore, isolated power conversion circuits offer the advantage of isolating high-voltage input voltage from output voltage, effectively preventing damage to humans or sensitive equipment from high voltage. However, this also makes it difficult for users or engineers to program the control circuit on the primary side of the isolated power conversion circuit.

Since isolated power conversion circuits are typically encased in a plastic housing, and users can only communicate with and receive the output voltage generated by the secondary side. Engineers often need to break the housing to access the primary-side control circuit for programming. To more efficiently program the primary-side control circuit of isolated power conversion circuits, it is necessary to improve traditional programming methods.

### BRIEF SUMMARY OF THE INVENTION

The present invention proposes an isolated power conversion circuit and a programming method thereof, enabling designers to program the control circuit located on the primary side of the transformer from the secondary side through the isolation device originally configured to generate the feedback signal. Therefore, the difficulty of controlling the primary side of the isolated power conversion circuit is significantly reduced, thereby reducing the cost of testing and improving the yield.

In an embodiment, a power conversion circuit is provided, which comprises an isolated power conversion circuit, an isolation device, a primary control circuit, and a secondary control circuit. The isolated power conversion circuit comprises a transformer, a high-side transistor, and a low-side transistor. The transformer comprises a primary coil and a secondary coil, where the secondary coil generates an output voltage. The high-side transistor is configured to provide an input voltage to the secondary coil. The low-side transistor is configured to couple the primary coil to a ground. The isolation device generates a feedback signal based on a feedback current. The primary control circuit drives the high-side transistor and the low-side transistor based on the feedback signal to magnetize and demagnetize the primary coil. The secondary control circuit generates the feedback current based on the output voltage. When the power conversion circuit operates in a programming mode, the secondary control circuit provides a program code to the primary control circuit through the isolation device based on a programming signal.

According to an embodiment of the present invention, when a programming device sets the output voltage as a first voltage, the secondary control circuit operates in the programming mode based on the output voltage being equal to the first voltage. When the output voltage is not equal to the first voltage, the secondary control circuit operates in a normal mode and generates the feedback current based on the output voltage.

According to an embodiment of the present invention, the power conversion circuit further comprises a full-wave rectification circuit and a power factor correction circuit. The full-wave rectification circuit is configured to convert an AC voltage into a first DC voltage. The power factor correction circuit is configured to convert the first DC voltage into the input voltage. The primary control circuit is further configured to control the full-wave rectification circuit and the power factor correction circuit.

According to an embodiment of the present invention, the power conversion circuit further comprises an AC-to-DC circuit. The AC-to-DC circuit is configured to convert the AC voltage into a second DC voltage. The primary control circuit is further configured to determine a voltage level of the AC voltage based on the second DC voltage.

According to an embodiment of the present invention, when the primary control circuit operates in the programming mode, the primary control circuit is powered by the second DC voltage.

According to an embodiment of the present invention, when the primary control circuit determines that the AC voltage is lower than a second voltage, the primary control circuit operates in the programming mode. When the AC voltage is not lower than the second voltage, the primary control circuit operates in a normal mode.

According to an embodiment of the present invention, the primary control circuit further determines whether the power frequency of the AC voltage is lower than a predetermined frequency. When the power frequency is lower than the predetermined frequency and the AC voltage is lower than the second voltage, the primary control circuit enters the programming mode.

According to an embodiment of the present invention, when the primary control circuit and the secondary control circuit both enter the programming mode, the secondary control circuit provides the programming code to the primary control circuit through the isolated device based on the programming signal received from a communication interface. When the primary control circuit and the secondary control circuit are both operating in the normal mode, the power conversion circuit communicates with an external device through the communication interface to adjust a voltage value of the output voltage.

According to an embodiment of the present invention, when the secondary control circuit operates in the programming mode, the secondary control circuit transmits an initial signal to the primary control circuit through the isolation device. When the primary control circuit operates in the programming mode, the primary control circuit drives the high-side transistor and the low-side transistor based on the initial signal to generate a notification signal. The secondary control circuit transmits an initial notification signal based on the notification signal and then starts to transmit the program code to the primary control circuit.

According to an embodiment of the present invention, the isolation power conversion circuit further comprises an output capacitor and a rectification diode. The output capacitor is coupled between one terminal of the secondary coil and the ground and configured to generate the output voltage. The rectification diode comprises an anode and a cathode, wherein the anode is coupled to the ground and the cathode is coupled to another terminal of the secondary coil. The secondary control circuit receives the notification signal from the cathode.

According to an embodiment of the present invention, the isolation device is an optocoupler.

According to another embodiment of the present invention, the isolation device is an isolation transformer.

In another embodiment, a programming method adapted to a power conversion circuit is provided. The power conversion circuit comprises an isolated power conversion circuit, an isolation device, and a primary control circuit, wherein the isolated power conversion circuit comprises a transformer, wherein the transformer comprises a primary coil and a secondary coil, wherein the secondary coil generates an output voltage, and the isolation device generates a feedback signal based on the output voltage, wherein the primary control circuit magnetizes and demagnetizes the primary coil based on the feedback signal, wherein the programming method comprises the following steps. It is determined whether the output voltage is equal to a first voltage. When the output voltage is equal to the first voltage, a program code is provided to the primary control circuit through the isolation device. The primary control circuit is programed based on the program code. When the power conversion circuit operates in a normal mode, the output voltage is equal to one of a plurality of predetermined voltage values. The first voltage is not equal to any one of the predetermined voltage values.

According to an embodiment of the present invention, the programming method further comprises the following steps. When the output voltage is equal to the first voltage, an initial signal is transmitted to the primary control circuit through the isolation device. It is determined whether a notification signal provided by the primary control circuit is received during a predetermined period. When the notification signal provided by the primary control circuit is received during the predetermined period, an initial notification signal is transmitted to the primary control circuit through the isolation device. When the notification signal provided by the primary control circuit is not received during the predetermined period, the programming method is ended.

According to an embodiment of the present invention, the programming method further comprises the following steps. A programming signal is received through a communication interface. After the step of transmitting the initial notification signal to the primary control circuit through the isolation device, programming instructions in the programming signal are translated into the program code. The program code is provided to the primary control circuit through the isolation device.

According to an embodiment of the present invention, when the programming method ends, the power conversion circuit communicates with an external device through the communication interface to adjust a voltage value of the output voltage.

According to an embodiment of the present invention, the power conversion circuit further comprises a full-wave rectification circuit and a power factor correction circuit. The full-wave rectification circuit is configured to convert an AC voltage into a DC voltage. The power factor correction circuit is configured to convert the DC voltage into an input voltage. The primary control circuit determines whether the AC voltage is lower than a second voltage.

According to an embodiment of the present invention, when the AC voltage is lower than the second voltage, the primary control circuit operates in a programming mode. When the AC voltage is not lower than the second voltage, the primary control circuit operates in a normal mode to magnetize and demagnetize the primary coil based on the feedback signal.

According to an embodiment of the present invention, the primary control circuit further determines whether a power frequency of the AC voltage is lower than a predetermined frequency. When the power frequency is lower than the predetermined frequency and the AC voltage is lower than the second voltage, the primary control circuit enters the programming mode.

According to an embodiment of the present invention, when the primary control circuit operates in the programming mode and receives the initial signal, the primary control circuit magnetizes and demagnetizes the primary coil to generate the notification signal on the secondary coil. The programming method further comprises the following steps. When the notification signal is received, an initial notification signal is transmitted to the primary control circuit through the isolation device. After the step of transmitting the initial notification signal to the primary control circuit through the isolation device, the program code is provided to the primary control circuit through the isolation device.

The present invention proposes an isolated power conversion circuit and a programming method thereof, enabling designers to program the control circuit located on the primary side of the transformer from the secondary side through the isolation device originally configured to generate the feedback signal. Therefore, the difficulty of controlling the primary side of the isolated power conversion circuit is significantly reduced, thereby reducing testing cost and improving yield.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a schematic diagram of a power conversion circuit operating in normal mode in accordance with an embodiment of the present invention;

FIG. 2 shows a schematic diagram of a power conversion circuit operating in programming mode in accordance with an embodiment of the present invention;

FIG. 3 shows a flowchart of a transmission method in accordance with an embodiment of the present invention; and

FIG. 4 shows a flowchart of a programming method in accordance with an embodiment of the present invention.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/- 20% of the stated value, more typically a range of +/- 10%, +/- 5%, +/- 3%, +/- 2%, +/- 1% or +/- 0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

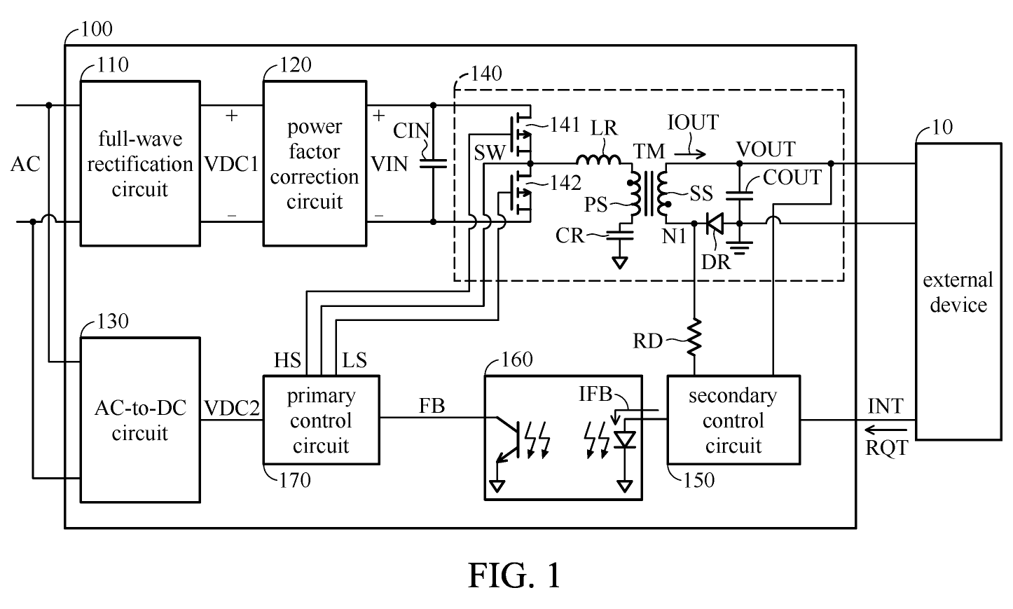

FIG. 1 shows a schematic diagram of a power conversion circuit operating in normal mode in accordance with an embodiment of the present invention. As shown in FIG. 1, the power conversion circuit 100 includes a full-wave rectification circuit 110, a power factor correction circuit 120, an AC-to-DC circuit 130, an isolated power conversion circuit 140, a secondary control circuit 150, an isolation device 160, and a primary control circuit 170.

The full-wave rectification circuit 110 receives an AC voltage AC and converts the AC voltage AC into a first DC voltage VDC1. The power factor correction circuit 120 converts the first DC voltage VDC1 into an input voltage VIN stored in the input capacitor CIN. The AC-to-DC circuit 130 converts the AC voltage AC into a second DC voltage VDC2.

The isolated power conversion circuit 140 includes a high-side transistor 141, a low-side transistor 142, a transformer TM, a resonant inductor LR, a resonant capacitor CR, a rectification diode DR, and an output capacitor COUT. The high-side transistor 141 provides the input voltage VIN to the switch node SW based on the high-side driving signal HS. The low-side transistor 142 couples the switch node SW to ground based on the low-side driving signal LS.

The transformer TM includes a primary coil PS and a secondary coil SS, where the resonant inductor LR, the primary coil PS, and the resonant capacitor CR are connected in series between the switch node SW and the ground. According to some embodiments of the invention, the resonant inductor LR may also be implemented by the leakage inductance of the primary coil PS. In other words, the resonant inductor LR can be omitted, and the primary coil PS and the resonant capacitor CR are coupled between the switch node SW and the ground.

According to some embodiments of the invention, when the high-side transistor 141 is turned on and the low-side transistor 142 is turned off, the input voltage VIN magnetizes the primary coil PS (i.e., the transformer TM) and charges the resonant capacitor CR. According to another embodiment of the present invention, when the high-side transistor 141 is turned off and the low-side transistor 142 is turned on, the primary coil PS (i.e., the transformer TM) demagnetizes, and the resonant capacitor CR is discharged.

The rectification diode DR includes an anode and a cathode, where the anode is coupled to ground, and the cathode is coupled to one terminal of the secondary coil SS. The output capacitor COUT is coupled between the other terminal of the secondary coil SS and ground. According to one embodiment of the present invention, when the primary coil PS magnetizes, the rectification diode DR is turned off. According to another embodiment of the present invention, when the primary coil PS demagnetizes, the rectification diode DR is turned on, causing the output current IOUT generated by the secondary coil SS to charge the output capacitor COUT, thereby generating an output voltage VOUT.

The secondary control circuit 150 generates a feedback current IFB based on the output voltage VOUT. The isolation device 160 generates a feedback signal FB based on the feedback current IFB. As shown in the embodiment of FIG. 1, the isolation device 160 may be an optocoupler, but is not limited thereto. According to other embodiments of the invention, the isolation device 160 may be an isolation transformer, and the power conversion circuit 100 may be modified accordingly.

The primary control circuit 170 generates a high-side driving signal HS and a low-side driving signal LS based on the feedback signal FB and the voltage of the switch node SW, thereby driving the high-side transistor 141 and the low-side transistor 142. According to some embodiments of the invention, the primary control circuit 170 determines the voltage value of the AC voltage AC based on the second DC voltage VDC2. According to some embodiments of the invention, the primary control circuit 170 may also determine the power supply frequency of the AC voltage AC (not shown in FIG. 1).

According to some embodiments of the invention, when the power conversion circuit 100 is electrically connected to the external device 10, the external device 10 transmits a request signal RQT through the communication interface INT to inform the power conversion circuit 100 of the required output voltage VOUT value. In other words, the secondary control circuit 150 adjusts the feedback current IFB based on the request signal RQT, causing the primary control circuit 170 to drive the high-side transistor 141 and the low-side transistor 142 based on the feedback signal FB, thereby generating the output voltage VOUT required by the external device 10.

According to an embodiment of the present invention, the communication interface INT may be a Universal Serial Bus (USB). According to another embodiment of the present invention, the communication interface INT may be a USB Power Delivery (USB PD). According to yet another embodiment of the present invention, the communication interface INT may also be an Inter-Integrated Circuit (I2C).

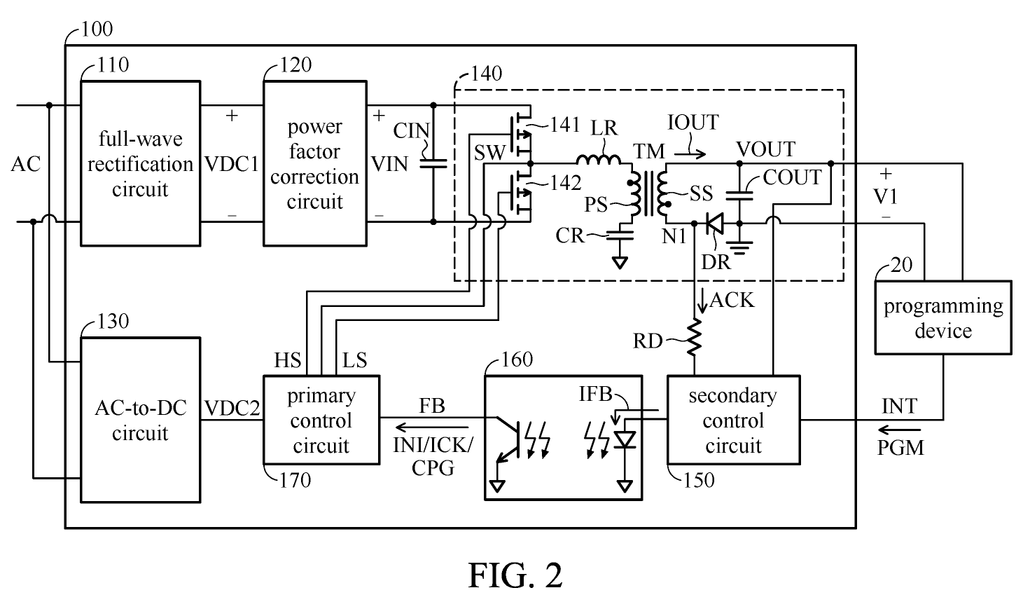

FIG. 2 shows a schematic diagram of a power conversion circuit operating in programming mode in accordance with an embodiment of the present invention. As shown in FIG. 2, the power conversion circuit 100 is electrically connected to the programming device 20. When the programming device 20 intends to program the power conversion circuit 100, it provides a first voltage V1 to the output voltage VOUT of the power conversion circuit 100, causing the power conversion circuit 100 to operate in programming mode, and transmits the programming signal PGM to the secondary control circuit 150 through the communication interface INT.

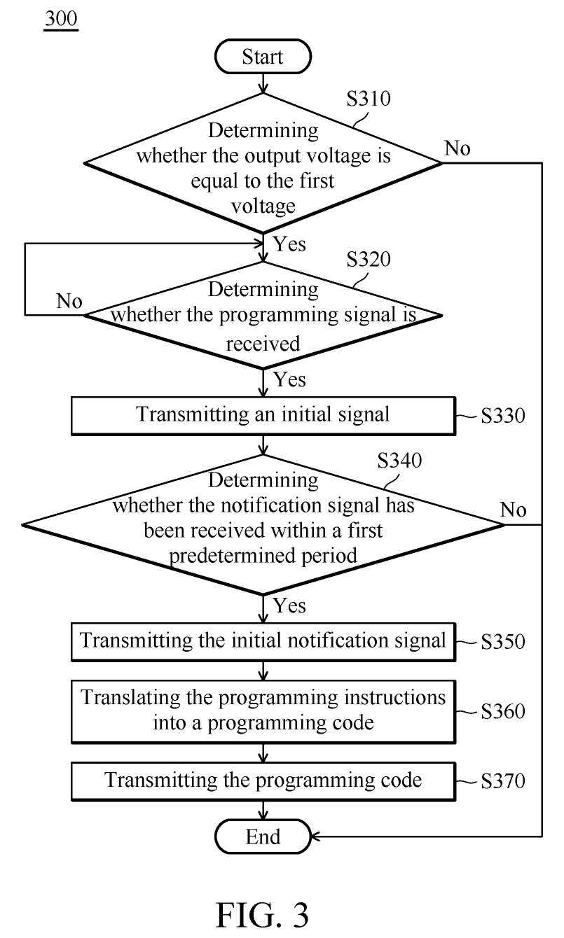

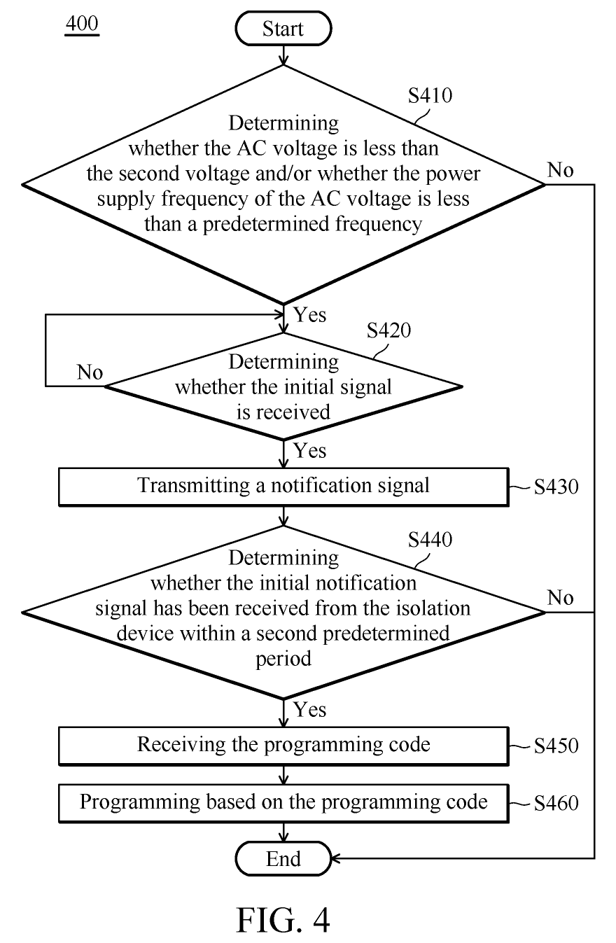

FIG. 3 shows a flowchart of a transmission method in accordance with an embodiment of the present invention. According to some embodiments of the present invention, the steps of the transmission method 300 are performed by the secondary control circuit 150 of FIG. 2. FIG. 4 shows a flowchart of a programming method in accordance with an embodiment of the present invention. According to some embodiments of the present invention, the steps of the programming method 400 are performed by the primary control circuit 170 of FIG. 2.

According to some embodiments of the present invention, the transmission method 300 of the secondary control circuit 150 combined with the programming method 400 of the primary control circuit 170 is the programming method performed by the power conversion circuit 100 when the programming device 20 programs the power conversion circuit 100. According to some embodiments of the present invention, the transmission method 300 can be considered as a programming method for the power conversion circuit 100, while the programming method 400 is an operation performed by the primary control circuit 170 corresponding to the transmission method 300. To explain the programming method of the power conversion circuit 100 in detail, the following paragraphs will describe the steps of the programming method proposed in the present invention in conjunction with the power conversion circuit 100 in FIG. 2, the transmission method 300 in FIG. 3, and the programming method 400 in FIG. 4.

When the programming device 20 programs the power conversion circuit 100, the programming device 20 first outputs a first voltage V1 to the output voltage VOUT, such that the output voltage VOUT is equal to the first voltage V1. The secondary control circuit 150 determines whether the output voltage VOUT is equal to the first voltage V1 (step S310). According to an embodiment of the present invention, when the output voltage VOUT is equal to the first voltage V1, the secondary control circuit 150 enters the programming mode. According to another embodiment of the present invention, when the output voltage VOUT is not equal to the first voltage V1, the secondary control circuit 150 enters the normal mode.

According to some embodiments of the present invention, when the power conversion circuit 100 of FIG. 1 operates in normal mode, the output voltage VOUT is one of the predetermined voltage values, where the first voltage V1 is not equal to any of the predetermined voltage values. In other words, the first voltage V1 is a voltage value other than the predetermined voltage values of the output voltage VOUT when the power conversion circuit 100 operates in normal mode. For example, the first voltage V1 may be 7.3V, but is not limited thereto.

When step S310 determines that it is yes, the secondary control circuit 150 determines whether the programming device 20 transmits the programming signal PGM via the communication interface INT (step S320). When step S310 determines that it is no, the transmission method 300 is terminated. According to some embodiments of the present invention, the termination of transmission method 300 is equivalent to the termination of the programming method of the power conversion circuit 100. When the programming signal PGM is received in step S320, the secondary control circuit 150 transmits an initial signal INI to the primary control circuit 170 via the isolation device 160 (step S330). When it is determined in step S320 that the programming signal PGM is not received, the secondary control circuit 150 continues to execute step S320 to wait for the programming signal PGM.

As shown in FIG. 4, the primary control circuit 170 determines whether the AC voltage AC is lower than the second voltage and/or whether the power supply frequency of the AC voltage AC is lower than a predetermined frequency (step S410). When step S410 determines yes, the primary control circuit 170 enters the programming mode and then determines whether the initial signal INI is received via the isolation device 160 (step S420). When step S410 determines no, the programming method 400 ends. According to some embodiments of the present invention, termination of the programming method 400 is equivalent to termination of the programming method of the power conversion circuit 100. According to some embodiments of the present invention, when the primary control circuit 170 operates in the programming mode, the primary control circuit 170 can be powered by the second DC voltage VDC2.

According to one embodiment of the present invention, the primary control circuit 170 determines whether the AC voltage AC is lower than the second DC voltage VDC2. According to an embodiment of the present invention, when the primary control circuit 170 only determines that the AC voltage AC is lower than the second voltage, the primary control circuit 170 enters the programming mode.

According to another embodiment of the present invention, when the primary control circuit 170 determines that the AC voltage AC is lower than the second voltage and the power supply frequency of the AC voltage AC is lower than a predetermined frequency, the primary control circuit 170 enters the programming mode. According to other embodiments of the present invention, the primary control circuit 170 can directly receive the AC voltage AC to determine whether the AC voltage AC is lower than the second voltage and whether the power supply frequency of the AC voltage AC is lower than a predetermined frequency.

According to some embodiments of the present invention, the programming device 20 can program the power conversion circuit 100 only when both the secondary control circuit 150 and the primary control circuit 170 are in the programming mode. That is, the power conversion circuit 100 enters the programming mode only when both the secondary control circuit 150 and the primary control circuit 170 are in the programming mode.

According to some embodiments of the present invention, when the output voltage VOUT is equal to the first voltage V1 and the AC voltage AC is lower than the second voltage, the power conversion circuit 100 operates in the programming mode, allowing the programming device 20 to program the power conversion circuit 100. According to other embodiments of the present invention, when the output voltage VOUT is equal to the first voltage V1, the AC voltage AC is lower than the second voltage, and the power supply frequency is lower than a predetermined frequency, the power conversion circuit 100 operates in the programming mode, allowing the programming device 20 to program the power conversion circuit 100. In other words, the power conversion circuit 100 can only enter the programming mode when both the output voltage VOUT and the AC voltage AC reach specific voltage values to prevent malfunctions.

When it is determined to be yes in step S420, the primary control circuit 170 drives the high-side transistor 141 and the low-side transistor 142 to cause the secondary coil SS to generate a notification signal ACK at the first node N1 (step S430). Returning to FIG. 3, after step S330, the secondary control circuit 150 determines whether it has received the notification signal ACK within a first predetermined period (step S340).

As shown in FIG. 2, the secondary control circuit 150 is coupled to the first node N1 through the detection resistor RD, and in step S340 determines whether it has received the notification signal ACK within a first predetermined period after the transmission of the initial signal INI. According to an embodiment of the present invention, when step S340 determines no, it means that the primary control circuit 170 may not have entered the programming mode for various reasons, or the initial signal INI may not have been successfully transmitted, thus ending the transmission method 300.

According to another embodiment of the present invention, when step S340 determines yes, the secondary control circuit 150 transmits the initial notification signal ICK to the primary control circuit 170 through the isolation device 160 (step S350). Next, the secondary control circuit 150 translates the programming instructions in the programming signal PGM into programming code CPG (step S360), and provides the programming code CPG to the primary control circuit 170 via the isolation device 160 (step S370). According to some embodiments of the present invention, after determining in step S320 that the programming signal PGM has been received, the programming instructions in the programming signal PGM are immediately translated into programming code CPG (step S360). After transmitting the initial notification signal ICK (step S350), the programming code CPG is immediately provided to the primary control circuit 170 (step S370).

Returning to FIG. 4, after step S430, the primary control circuit 170 determines whether it has received the initial notification signal ICK from the isolation device 160 within a second predetermined period (step S440). When step S440 determines no, the primary control circuit 170 ends the programming method 400. When step S440 determines that it is yes, the primary control circuit 170 receives the programming code CPG from the isolation device 160 (step S450) and performs programming based on the programming code CPG (step S460).

According to some embodiments of the present invention, when either the transmission method 300 or the programming method 400 ends, it represents the end of the programming method, and the power conversion circuit 100 returns to normal mode. When the power conversion circuit 100 operates in normal mode and is electrically connected to the external device 10, the power conversion circuit 100 can communicate with the external device 10 through the communication interface INT, thereby adjusting the voltage value of the output voltage VOUT.

The present invention proposes an isolated power conversion circuit and a programming method thereof, enabling designers to program the control circuit located on the primary side of the transformer from the secondary side through the isolation device originally configured to generate the feedback signal. Therefore, the difficulty of controlling the primary side of the isolated power conversion circuit is significantly reduced, thereby reducing the cost of testing and improving the yield.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A power conversion circuit, comprising:
an isolated power conversion circuit, comprising:
a transformer, comprising a primary coil and a secondary coil, wherein the secondary coil generates an output voltage;
a high-side transistor, configured to provide an input voltage to the secondary coil; and
a low-side transistor, configured to couple the primary coil to a ground;
an isolation device, generating a feedback signal based on a feedback current;
a primary control circuit, driving the high-side transistor and the low-side transistor based on the feedback signal to magnetize and demagnetize the primary coil; and
a secondary control circuit, generating the feedback current based on the output voltage;
wherein when the power conversion circuit operates in a programming mode, the secondary control circuit provides a program code to the primary control circuit through the isolation device based on a programming signal.

2. The power conversion circuit as claimed in claim 1, wherein when a programming device sets the output voltage as a first voltage, the secondary control circuit operates in the programming mode based on the output voltage being equal to the first voltage;
wherein when the output voltage is not equal to the first voltage, the secondary control circuit operates in a normal mode and generates the feedback current based on the output voltage.

3. The power conversion circuit as claimed in claim 1, further comprising:
a full-wave rectification circuit, configured to convert an AC voltage into a first DC voltage; and
a power factor correction circuit, configured to convert the first DC voltage into the input voltage;
wherein the primary control circuit is further configured to control the full-wave rectification circuit and the power factor correction circuit.

4. The power conversion circuit as claimed in claim 3, further comprising:
an AC-to-DC circuit, configured to convert the AC voltage into a second DC voltage;
wherein the primary control circuit is further configured to determine a voltage level of the AC voltage based on the second DC voltage.

5. The power conversion circuit as claimed in claim 4, wherein when the primary control circuit operates in the programming mode, the primary control circuit is powered by the second DC voltage.

6. The power conversion circuit as claimed in claim 4, wherein when the primary control circuit determines that the AC voltage is lower than a second voltage, the primary control circuit operates in the programming mode;
wherein when the AC voltage is not lower than the second voltage, the primary control circuit operates in a normal mode.

7. The power conversion circuit as claimed in claim 6, wherein the primary control circuit further determines whether a power frequency of the AC voltage is lower than a predetermined frequency;
wherein when the power frequency is lower than the predetermined frequency and the AC voltage is lower than the second voltage, the primary control circuit enters the programming mode.

8. The power conversion circuit as claimed in claim 6, wherein when the primary control circuit and the secondary control circuit both enter the programming mode, the secondary control circuit provides the programming code to the primary control circuit through the isolated device based on the programming signal received from a communication interface;
wherein when the primary control circuit and the secondary control circuit are both operating in the normal mode, the power conversion circuit communicates with an external device through the communication interface to adjust a voltage value of the output voltage.

9. The power conversion circuit as claimed in claim 4, wherein when the secondary control circuit operates in the programming mode, the secondary control circuit transmits an initial signal to the primary control circuit through the isolation device;
wherein when the primary control circuit operates in the programming mode, the primary control circuit drives the high-side transistor and the low-side transistor based on the initial signal to generate a notification signal;
wherein the secondary control circuit transmits an initial notification signal based on the notification signal and then starts to transmit the program code to the primary control circuit.

10. The power conversion circuit as claimed in claim 9, wherein the isolation power conversion circuit further comprises:
an output capacitor, coupled between one terminal of the secondary coil and the ground and configured to generate the output voltage; and
a rectification diode, comprising an anode and a cathode, wherein the anode is coupled to the ground and the cathode is coupled to another terminal of the secondary coil;
wherein the secondary control circuit receives the notification signal from the cathode.

11. The power conversion circuit as claimed in claim 1, wherein the isolation device is an optocoupler.

12. The power conversion circuit as claimed in claim 1, wherein the isolation device is an isolation transformer.

13. A programming method adapted to a power conversion circuit, wherein the power conversion circuit comprises an isolated power conversion circuit, an isolation device, and a primary control circuit, wherein the isolated power conversion circuit comprises a transformer, wherein the transformer comprises a primary coil and a secondary coil, wherein the secondary coil generates an output voltage, and the isolation device generates a feedback signal based on the output voltage, wherein the primary control circuit magnetizes and demagnetizes the primary coil based on the feedback signal, wherein the programming method comprises:
determining whether the output voltage is equal to a first voltage; and
when the output voltage is equal to the first voltage, providing a program code to the primary control circuit through the isolation device;
wherein the primary control circuit is programed based on the program code;
wherein when the power conversion circuit operates in a normal mode, the output voltage is equal to one of a plurality of predetermined voltage values;
wherein the first voltage is not equal to any one of the predetermined voltage values.

14. The programming method as claimed in claim 13, further comprising:
when the output voltage is equal to the first voltage, transmitting an initial signal to the primary control circuit through the isolation device;
determining whether a notification signal provided by the primary control circuit is received during a predetermined period;
when the notification signal provided by the primary control circuit is received during the predetermined period, transmitting an initial notification signal to the primary control circuit through the isolation device; and
when the notification signal provided by the primary control circuit is not received during the predetermined period, ending the programming method.

15. The programming method as claimed in claim 14, further comprising:
receiving a programming signal through a communication interface;
after the step of transmitting the initial notification signal to the primary control circuit through the isolation device, translating programming instructions in the programming signal into the program code; and
providing the program code to the primary control circuit through the isolation device.

16. The programming method as claimed in claim 15, wherein when the programming method ends, the power conversion circuit communicates with an external device through the communication interface to adjust a voltage value of the output voltage.

17. The programming method as claimed in claim 14, wherein the power conversion circuit further comprises a full-wave rectification circuit and a power factor correction circuit;
wherein the full-wave rectification circuit is configured to convert an AC voltage into a DC voltage;
wherein the power factor correction circuit is configured to convert the DC voltage into an input voltage;
wherein the primary control circuit determines whether the AC voltage is lower than a second voltage.

18. The programming method as claimed in claim 17, wherein when the AC voltage is lower than the second voltage, the primary control circuit operates in a programming mode;
wherein when the AC voltage is not lower than the second voltage, the primary control circuit operates in a normal mode to magnetize and demagnetize the primary coil based on the feedback signal.

19. The programming method as claimed in claim 18, wherein the primary control circuit further determines whether a power frequency of the AC voltage is lower than a predetermined frequency;
wherein when the power frequency is lower than the predetermined frequency and the AC voltage is lower than the second voltage, the primary control circuit enters the programming mode.

20. The programming method as claimed in claim 18, wherein when the primary control circuit operates in the programming mode and receives the initial signal, the primary control circuit magnetizes and demagnetizes the primary coil to generate the notification signal on the secondary coil;
wherein the programming method further comprises:
when the notification signal is received, transmitting an initial notification signal to the primary control circuit through the isolation device; and
after the step of transmitting the initial notification signal to the primary control circuit through the isolation device, providing the program code to the primary control circuit through the isolation device.
